(19) United States
(12) Patent Application Publication
(10) Pub. No.: US 2015/0019568 A1
(43) Pub. Date: Jan. 15, 2015

(54) IDENTIFYING WORD-OF-MOUTH INFLUENCERS USING TOPIC MODELING AND INTERACTION AND ENGAGEMENT ANALYSIS

(71) Applicant: READZ S.A., Luxemburg (DE)

(72) Inventors: Bart De Pelsmaeker, Agoura Hills, CA (US); Ariel Yaar, Thousand Oaks, CA (US); Chris Huber-Lantz, North Hollywood, CA (US)

(21) Appl. No.: 14/329,320

(22) Filed: Jul. 11, 2014

Related U.S. Application Data
(60) Provisional application No. 61/845,881, filed on Jul. 12, 2013.

(51) Int. Cl. G06F 17/30

(52) U.S. Cl. CPC G06F 17/30522
USPC 707/748

(57) ABSTRACT

A method includes receiving information related to user generated content within a plurality of social networks and categorizing the information. The method further includes, using the categorized information, identifying relationships between a first user and a plurality of second users, scoring each relationship between the first user and a respective one of the plurality of second users, and providing a list of recommended users of the plurality of second users. Categorizing the information may include weighting the information. The method may further include identifying affinities of the second users for a product or category of products using the categorized information. The method may further include calculating a recommendation score for each of the plurality of second users based on the score for each relationship and the affinities, wherein the list of recommended users is based on the recommendation scores of the plurality of second users.

### CROSS-REFERENCE TO RELATED PATENT APPLICATIONS

This application claims the benefit of U.S. Provisional Patent Application 61/845,881 filed Jul. 12, 2013 to De Pelsmaeker et al., titled “IDENTIFYING WORD-OF-MOUTH INFLUENCERS USING TOPIC MODELING AND INTERACTION AND ENGAGEMENT ANALYSIS,” the contents of which are incorporated herein by reference in their entirety.

### BACKGROUND

In the field of social media network analysis, present marketing techniques rely on a theory that people will be influenced by individuals having a large presence in a social media network. It would be beneficial to instead consider personal relationships and interests in determining actual influencers.

### SUMMARY

The present disclosure is directed towards determining affinities and relationships to rank and categorize users.

In a first aspect, a method includes receiving information related to user generated content within a plurality of social networks and categorizing the information. The method further includes, using the categorized information, identifying relationships between a first user and a plurality of second users, scoring each relationship between the first user and a respective one of the plurality of second users, and providing a list of recommended users of the plurality of second users. Categorizing the information may include weighting the information. The method may further include identifying affinities of the second users for a product or category of products using the categorized information. The method may further include calculating a recommendation score for each of the plurality of second users based on the score for each relationship and the affinities, wherein the list of recommended users is based on the recommendation scores of the plurality of second users.

In a second aspect, a method includes receiving information related to user generated content within at least one social network, identifying from the information a relationship between a first user and a second user, calculating a strength of relationship score for the relationship, identifying from the information an affinity of the second user for a product or category of product, calculating an affinity score for the second user, and determining a recommendation score for the second user based on the strength of relationship score and the affinity score.

In a third aspect, a method includes gathering information related to topical affinities of an individual by electronically scanning a first social network using a first crawler, and gathering information related to one or more relationships of the individual by electronically scanning a second social network using a second crawler. The method further includes determining a strength of relationship score for each of the relationships of the individual based on the information gathered from the second social network, calculating a ranking of each of the relationships of the individual based on the strength of relationship scores and the topical affinities of the individual, and providing a recommendation list of persons most likely to be influenced by the individual based on the ranking.

### BRIEF DESCRIPTION OF THE DRAWINGS

FIG. 1 is a representation of one environment for social media network analysis.

FIG. 2 is a representation of an example of a computing device.

FIG. 3 is a representation of an example of a social network analysis engine in an environment.

FIG. 4 is a representation of examples of types of user information analyzed.

FIG. 5 is a representation of examples of categorization.

FIG. 6 illustrates one embodiment of a welcome screen of a graphical user interface.

FIG. 7 illustrates one embodiment of a presentation of engagement ratios on a graphical user interface.

FIG. 8 illustrates one embodiment of a presentation of engagement ratios and sub-ratios on a graphical user interface.

FIG. 9 illustrates one embodiment of a presentation of affinity ratios on a graphical user interface.

FIG. 10 illustrates one embodiment of a presentation of affinity ratios and sub-ratios on a graphical user interface.

### DETAILED DESCRIPTION

Social Media Network Analysis (SMNA) has become a popular discipline in marketing. “Influence marketing” based on SMNA identifies “influencers”. In present SMNA methodologies, a “key influencer” analysis run on a social network will provide information about individuals who have a large following, have a high occurrence of broadcasts on a certain topic, or receive a lot of “engagements” about a topic. This sort of “key influencer” analysis is based on the theory that people will put greater value in advice and opinions received from such individuals.

Influence marketing as performed by brands and enterprises includes identifying key influencers on certain topics, and then approaching these key influencers to promote branded content or product messages. These key influencers theoretically maximally spread the marketing messages.

The influence marketing described above relies on a theory that people will actually be influenced by individuals who have a large presence in a social media network.

The present disclosure, in contrast, describes a technique for identifying actual influencers and the persons that they influence. The technique reveals within a specific individual's network persons in that network that have (1) a strong relationship with the individual and (2) an interest or affinity with a selected topic. Therefore, persons are identified according to their estimated receptiveness to a particular message based on their relationships and existing interactions. Such an approach reveals actual influential relationships, whether the influencing individual has only one follower or one million followers.

Within present marketing approaches, it is left to an individual to decide to whom they wish to pass information. For example, in a ‘share’ of content, the individual decides with whom to share. This requires a conscious thought process on the part of the recommending individual, and as such creates a lower occurrence of sharing. This is sometimes resolved in current applications with “general broadcasts”, where an individual's recommendation is broadcast to all persons within an individual's community. These sort of broadcasts are very often, and quickly, perceived as spam by persons not so closely connected to the broadcasting individual. An individual may therefore be reluctant to do a broadcast recommendation.

In contrast, the present disclosure describes providing to an individual a list of persons who are most likely to respond positively to a particular recommendation. A social network analysis engine (SNAE) analyzes an individual's social network or networks.

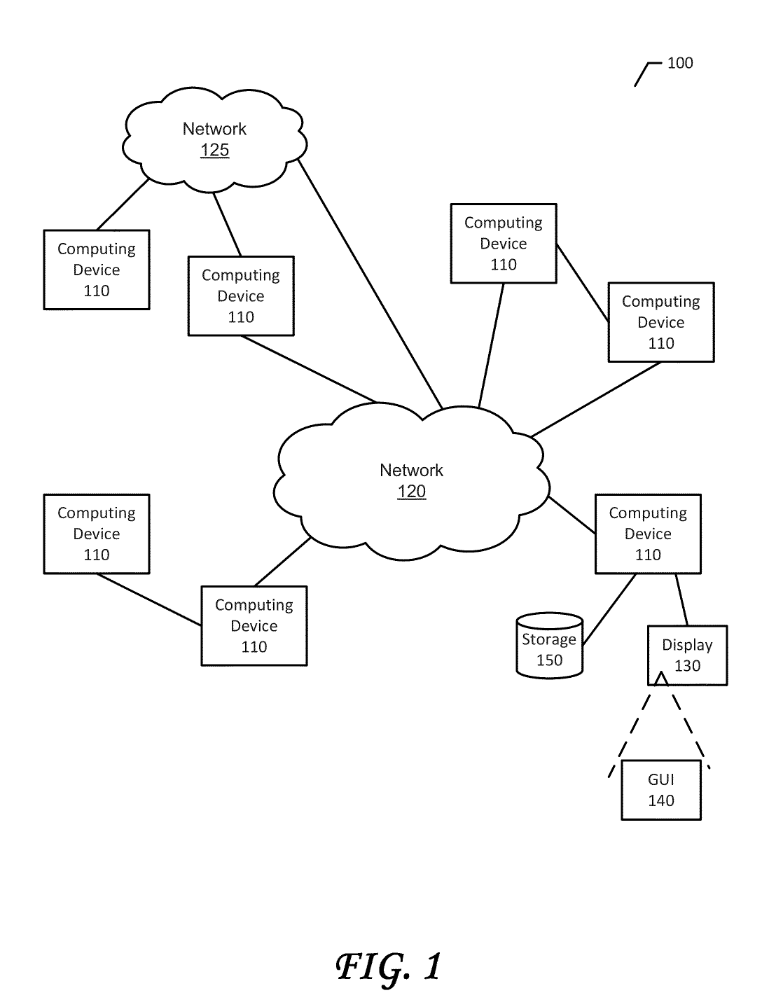

FIG. 1 represents an environment 100 in which the SNAE of this disclosure may be implemented, in which multiple computing devices 110 are in communication with each other via one or more networks, such as network 120 or 125. A computing device 110 may be associated with a display 130 including a graphical user interface (GUI) 140, and a storage 150.

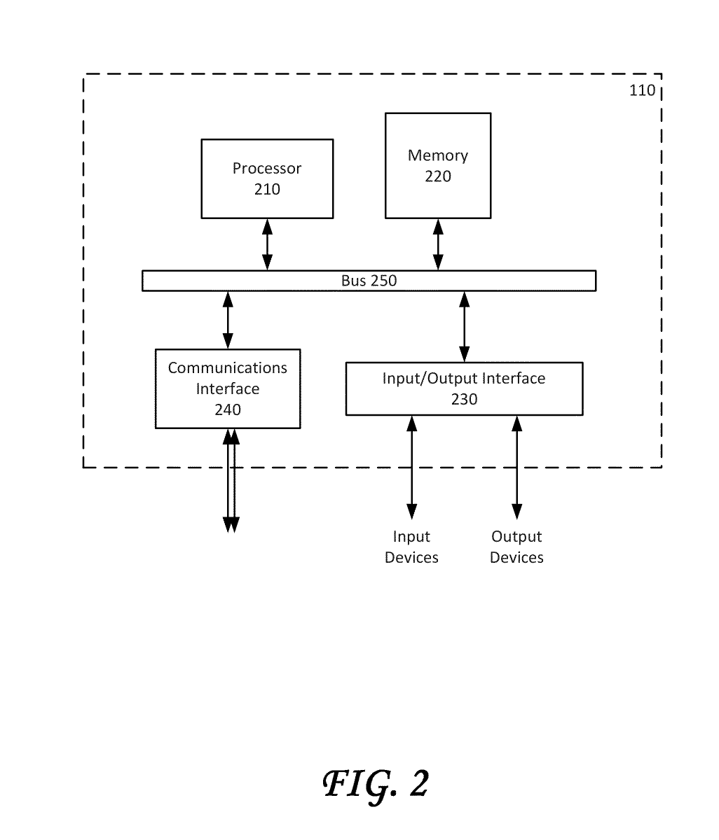

Computing device 110 may be, for example, a server, a desktop computer, a laptop computer, a notebook computer, a netbook, a reader, a personal digital assistant (PDA), a smart phone, a wrist computer, or any other device configured to implement computer-readable instructions from one or more of, or a combination of, hardware or firmware. Computing devices are described in more detail with respect to FIG. 2.

Networks 120 and 125 represent one or more private or public networks, such as one of, or a combination of, the Internet, or a CDMA or GSM network, or other communication network.

Display 130 represents a monitor, an LCD, LED, or plasma screen, an image projection, or other device capable of providing information visually to a user.

GUI 140 represents a program that provides information to display 130 so that the information may be presented in a format that is understandable to a user.

Storage 150 represents one or more memory devices for storing instructions and/or data. The SNAE of this disclosure may be implemented as computer-executable instructions in storage 150, executed by computing device 110.

FIG. 2 represents an example of a computing device 110 that includes a processor 210, a memory 220, an input/output interface 230, and a communication interface 240. A bus 250 provides a communication path between two or more of the components of computing device 110. The components shown are provided by way of illustration and are not limiting. Computing device 110 may have additional or fewer components, or multiple of the same component.

Processor 210 represents one or more of a processor, microprocessor, microcontroller, ASIC, and/or FPGA, along with associated logic.

Memory 220 represents one or both of volatile and non-volatile memory for storing information. Examples of memory include semiconductor memory devices such as EPROM, EEPROM and flash memory devices, magnetic disks such as internal hard disks or removable disks, magneto-optical disks, CD-ROM and DVD-ROM disks, and the like. Storage 150 may include memory 220 and other fixed or removable storage devices. The SNAE of this disclosure may be implemented as computer-readable instructions in memory 220 of computing device 110, executed by processor 210.

An embodiment of the disclosure relates to a non-transitory computer-readable storage medium having computer code thereon for performing various computer-implemented operations. The term “computer-readable storage medium” is used herein to include any medium that is capable of storing or encoding a sequence of instructions or computer codes for performing the operations, methodologies, and techniques described herein. The media and computer code may be those specially designed and constructed for the purposes of the embodiments of the disclosure, or they may be of the kind well known and available to those having skill in the computer software arts. Examples of computer-readable storage media include, but are not limited to: magnetic media such as hard disks, floppy disks, and magnetic tape; optical media such as CD-ROMs and holographic devices; magneto-optical media such as optical disks; and hardware devices that are specially configured to store and execute program code, such as application-specific integrated circuits (“ASICs”), programmable logic devices (“PLDs”), and ROM and RAM devices.

Examples of computer code include machine code, such as produced by a compiler, and files containing higher-level code that are executed by a computer using an interpreter or a compiler. For example, an embodiment of the disclosure may be implemented using Java, C++, or other object-oriented programming language and development tools. Additional examples of computer code include encrypted code and compressed code. Moreover, an embodiment of the disclosure may be downloaded as a computer program product, which may be transferred from a remote computer (e.g., a server computer) to a requesting computer (e.g., a client computer or a different server computer) via a transmission channel. Another embodiment of the disclosure may be implemented in hardwired circuitry in place of, or in combination with, machine-executable software instructions.

Input/output interface 230 represents electrical components and optional code that together provide an interface from the internal components of computing device 110 to external components. Examples include a driver integrated circuit with associated programming.

Communications interface 240 represents electrical components and optional code that together provide an interface from the internal components of computing device 110 to external networks, such as network 120 or network 125.

Bus 250 represents one or more interfaces between components within computing device 110. For example, bus 250 may include a dedicated connection between processor 210 and memory 220 as well as a shared connection between processor 210 and multiple other components of computing device 110.

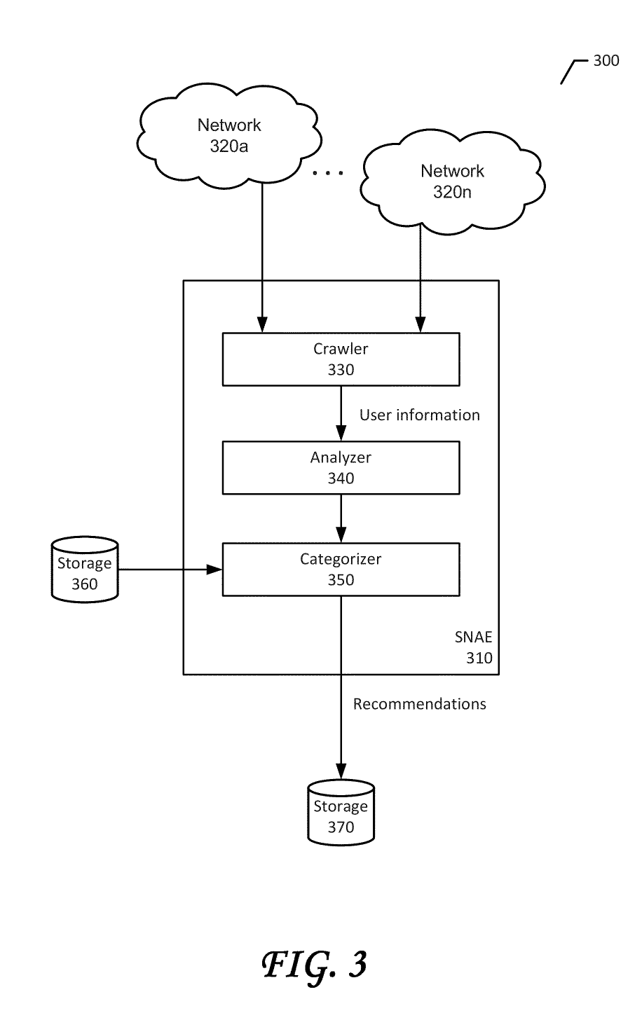

FIG. 3 represents an example of an SNAE 310 implemented in an environment 300 in which SNAE 310 is communicatively coupled to networks 320a to 320n. Networks 320a-320n represent a capability of SNAE 310 to communicate over one or more networks, such as network 120 or 125. Hosts, including social media sites such as Twitter, Facebook, LinkedIn, blogs, forums, and websites may be located within the network(s). User-generated content (UGC) may be accessible at a host. A network including a host for UGC is referred to herein as a UGC network. UGC may be, for example, an individual's profile, indicated preferences and keywords, messages or posts, likes, and so on. By way of example, in one embodiment, the UGC is Twitter content, including profiles, hashtags, favorited tweets, tweets, direct messages, and so forth.

Information may be extracted from a UGC network by one or more crawlers, which are deployed to extract certain desired information without making a copy of all information present on the network.

In FIG. 3, SNAE 310 is shown as including a crawler 330 to crawl identified sources such as one or more hosts, analyzer 340 to analyze one or more social networks, and categorizer 350 to provide recommendations based on information found by crawler 330. SNAE 310 may additionally use content preferences in determining the categorizations and rankings, where the content preferences may be previously determined and saved in a storage 360.

Storage 360 and storage 370 may be, but are not necessarily, implemented together physically or relationally. The information in storage 370 may, for example, be viewed through a GUI, or may be used to generate one or more reports electronically or in physical form.

SNAE 310 is implemented on a computing device, such as on a computing device 110. Alternatively, portions of SNAE 310 may be implemented on different computing devices. For example, crawler 330, an analyzer 340, and a categorizer 350 may each be implemented on different servers, or may be distributed across multiple servers or other computer-based platforms.

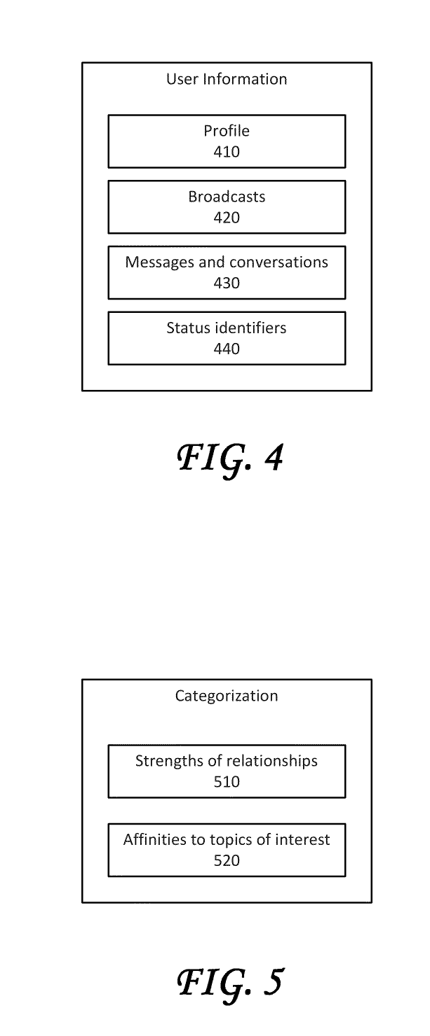

FIG. 4 illustrates some types of information that may gathered from a UGC network to build a recommendation, such as a profile 410, broadcasts 420, messages and conversations 430, and status identifiers 440.

A profile 410 of an individual may include interests, keywords, status, location and other descriptors. A broadcast 420 by an individual may include interests, keywords, status, location and other descriptors. Messages and conversations 430 between individuals may include interests, keywords, status, location and other descriptors. Status identifiers 440 may include geographical or point-of-interest location, memberships in specific interest groups, and other information. Additional information may be gathered from a UGC network, including information from other types of UGC not listed above.

Information gathered from the UGC network(s) is analyzed to identify relationships between individuals and to identify content affinities. The analysis may be performed for a single UGC network or across multiple UGC networks.

A specific example related to a single UGC network is the discovery of a relationship on the Twitter UGC social network based on the frequency of direct messages, along with the discovery of an interest based upon broadcasts to respective followerships on Twitter. The relationships and interests from the single Twitter UGC network may then be used for the analysis.

Performing the analysis across multiple UGC networks may provide for improved determination of relationships and content affinities. For example, a strong personal relationship may be uncovered on a first UGC network, while an affinity for a specific content topic may be uncovered on a second UGC network. The combined information from the first and second UGC networks in this example may be used to create a single recommendation. A specific example is the discovery of a strong relationship on the Facebook UGC network, and the discovery of a common interest on the LinkedIn UGC network.

FIG. 5 illustrates that, after the information from the UGC networks is analyzed, a categorization is performed. Categorization includes categorizing strengths of relationships (510) between individuals, and affinities to topics of interest (520). For example, strength of a relationship may be based on a number of message exchanges, a mutual follow relationship, retweets, direct messages, favorites, and the like. Affinity to a specific topic may be determined, for example, based on categories that group a set of pre-defined or automatically generated keywords.

Categorization may be identified using a trained model. Trained model associations may be manually defined, or alternatively may be self-learned. The trained model assigns weights and importance to the two components (1) strength of relationship and (2) affinity with content.

A ranking may also be performed, to identify individuals who are most likely to act upon word-of-mouth recommendations from a specific individual.

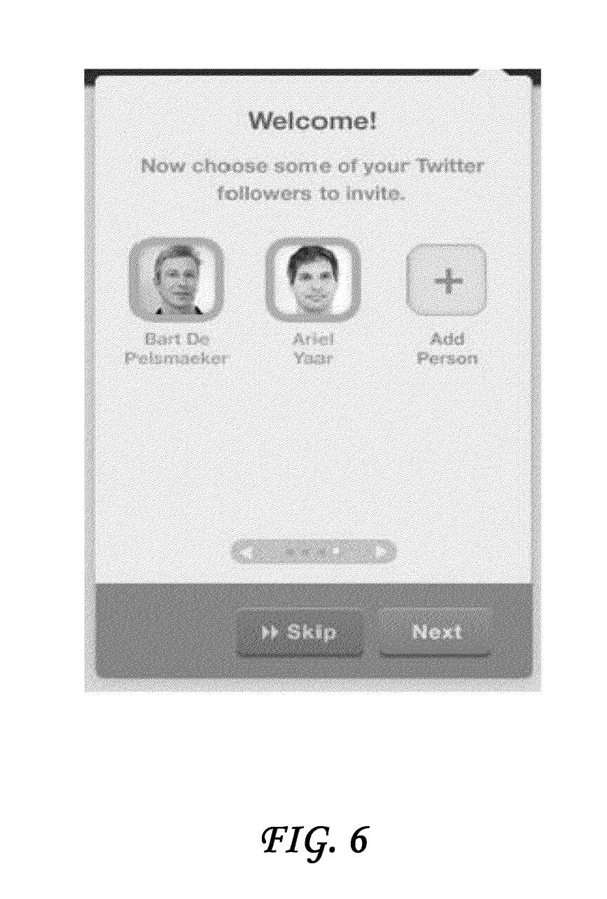

FIG. 6 illustrates an example of a welcome screen for one embodiment of a GUI for displaying categorization and ranking for word-of-mouth relationships. A GUI may be designed for a recommender or advertiser. An embodiment of a GUI may include, for example, tree-like structures showing word-of-mouth relationships in a one-dimensional order.

Having described the SNAE in overview, examples of categorizations are next provided, followed by examples of implementations. These examples are provided by way of illustration to better understand the concepts presented in this disclosure, and not by way of limitation. The examples are provided based on functionalities presently available from the associated hosts. As the hosts make new functionalities available, scoring and ranking may be alternatively or additionally determined based on features related to the new functionalities. In the examples, the terms “engagement ratio” and “affinity ratio” are used to indicate a ranking based on a ratiometric score (e.g., 3 out of 5). In other embodiments, different scoring may be used, such as an absolute score or a relative score. Additionally, although scoring is represented using stars in the examples, a number, a letter, or any other visualization may be used to present a score.

### Examples of Categorization

### EXAMPLE 1

### Twitter-Based Categorization

An embodiment of a categorization for the Twitter UGC social network is next described.

a. Strength of Relationship

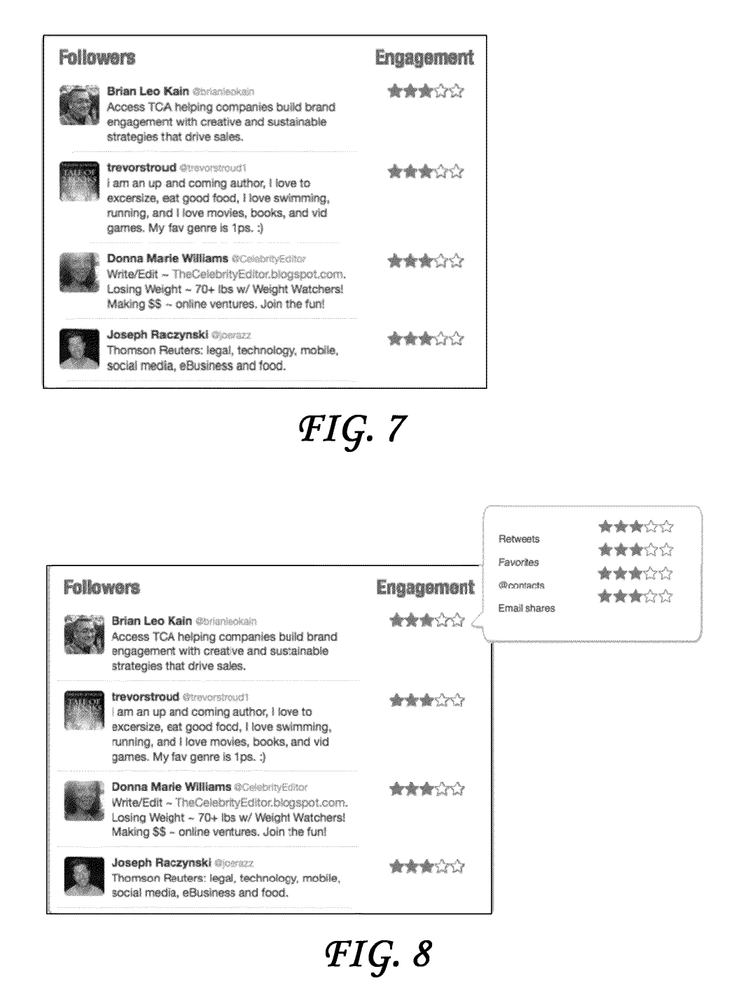

Strength of relationship may be measured in Twitter by looking at engagements between an originating individual and the individual's followers. FIG. 7 illustrates the use of an engagement ratio to indicate strength of relationship.

In some embodiments, an engagement ratio between an individual and a follower may be calculated based upon identified numbers of “retweets”, “favored”, and “@messages”, where:
“retweets” is the number of retweets in the followers' timeline of messages of tweets from the originators' timeline;
“favored” is the number of favored tweets by the follower; and
“@messages” is the number of tweets in the followers' timeline that contain the originator's Twitter @handle (the Twitter name of the originator).

In other embodiments, the engagement ratio may be alternatively or additionally calculated based on one or more of “direct messages” or “shares”, where:
“direct messages” is the number of direct messages from the originator's follower to the originator; and
“shares” is the number of shares of tweets by the follower of tweets from the originators' timeline.

As a further enhancement, the engagement ratio may alternatively or additionally be calculated based on mutuality of engagement. Mutuality of engagement may be measured by, for example, the number of tweets of the follower retweeted by the originator, the number of tweets of the follower favored by the originator, the @messages in the originator's timeline that contain the follower's Twitter handle (including replies), the number of direct messages from the originator to the originator's follower, or the number of shares of tweets by the follower of tweets from the originators' timeline.

FIG. 8 illustrates that a ratio may include sub-ratios, which may be provided at a GUI. In FIG. 8, example sub-ratios of the engagement ratio for “Retweets”, “Favorites”, “@contacts”, and “Email shares” are shown.

b. Affinity with Topics

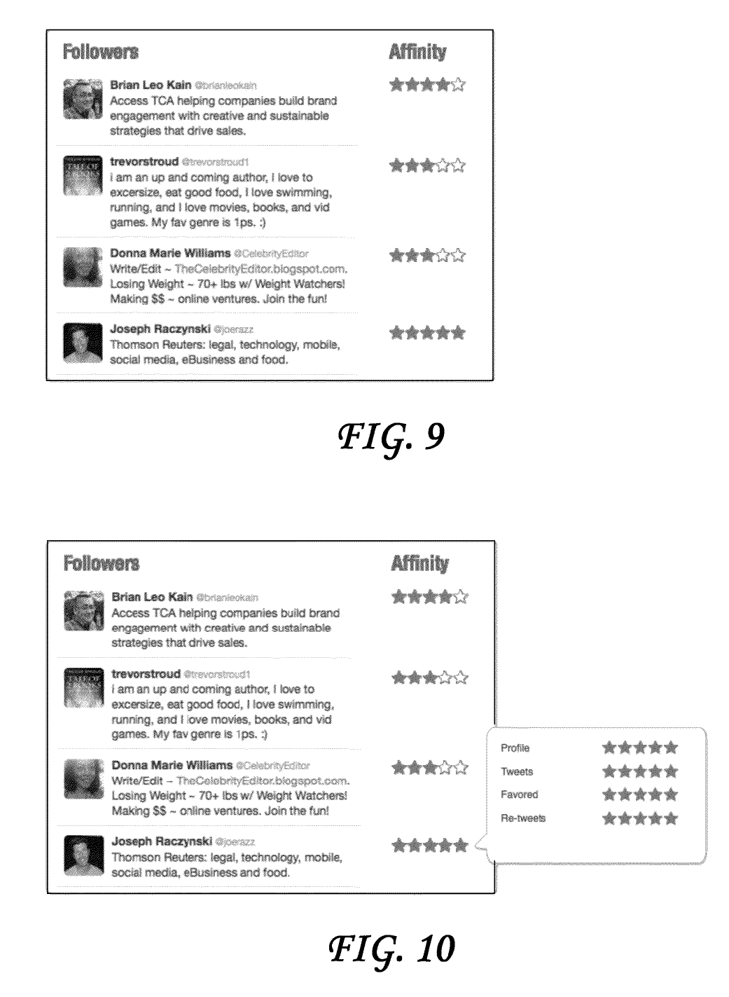

Affinity with topics may be measured in the Twitter social network by performing an analysis of UGC content in the network. FIG. 9 illustrates the use of an affinity ratio to indicate a ranking of users with respect to a specific topic or category of topics, or for a defined set of interests described by keywords.

The affinity ratio between an individual and a follower may be calculated based on, for example, “profile”, “tweets”, “favored”, and “retweets”, where:
“profile” measures whether the profile of the follower contains one of the specified keywords, preceded by a # hashtag or not;
“tweets” is the number of times tweets by the follower contain one of the specified keywords, preceded by a # hashtag or not;
“favored” is the number of times favored tweets by the follower contain one of the specified keywords, preceded by a # hashtag or not; and
“retweets” is the number of times tweets by the follower contain one of the specified keywords, preceded by a # hashtag or not.

In another embodiment, the affinity ratio may alternatively or additionally be calculated based on “direct messages”, which is the number of times direct messages by the follower contain one of the specified keywords, preceded by a # hashtag or not.

FIG. 10 illustrates that an affinity ratio may include sub-ratios, which may be provided at a GUI. As shown by way of example in FIG. 10, the sub-ratios for affinity may include “Profile”, “Tweets”, “Favored”, and “Retweets”, among others.

Affinity data as analyzed for a different UGC network may also be incorporated into the Twitter affinity analysis.

c. Trained Model

The ranking in the Twitter embodiment may be based on a trained model which produces a score (such as engagement ratio or affinity ratio) for each user or group of users. The trained model in the Twitter embodiment assigns weights to each of the components which form a category. These weights are then multiplied with their respective components, and the sum of the multiplications result in the score for that category. The engagement ratio and affinity ratio are defined in one embodiment for the Twitter environment as:

Engagement ratio=(w_{—}a*“retweets”)+(w_{—}b*“favored”)+(w_{—}c*“@messages”)

Affinity ratio=(w_{—}d*“profile”)+(w_{—}e*“tweets”)+(w_{—}f*“favored”)+(w_{—}g*“retweets”)

where w_n is the weight specified for a particular component in the equation.

A recommendation score may be based on one or both of engagement ratio and affinity ratio, and may be a weighted sum of the engagement ratio and affinity ratio:

Recommendation score=(w_{—}x*engagement ratio)+(w_{—}y*affinity ratio)

One or more of the engagement ratio, affinity ratio, sub-ratios of the engagement ratio or affinity ratio, or the recommendation score may be refined by taking into account the timing of the components underlying the scores. For many of the components, it may be more informative to reveal more recent interactions, as relationships and affinity can change over time, and more recent ones are more likely to result in positive engagement. To give preference to more recent interactions, a “decay” factor may be used. For example, a decay factor may be based on the date when the relevant component occurred, and then a logarithmic function applied which produces a score between 0 to 1, where the logarithmic function variables may be set to create smaller or larger differentiation between older and newer occurrences of components. In one embodiment, decay is considered as follows:

Decay engagement ratio=(D_{—}a*w_{—}a*“retweets”)+(D_{—}b*w_{—}b*“favored”)+(D_{—}c*w_{—}c*“@messages”)

Decay affinity ratio=(D_{—}d*w_{—}d*“profile”)+(D_{—}e*w_{—}e*“tweets”)+(D_{—}f*w_{—}f*“favored”)+(D_{—}g*w_{—}g*“retweets”)

Decay recommendation score=(D_{—}x*w_{—}x*engagement ratio score)+(D_{—}y*w_{—}y*affinity ratio score)

where D_n is the decay specified for a particular component in the equation.

A learning factor may further be included. By tracking the occurrence of the desired results or desired actions, a relationship can be discovered between the different components and the chance of success for the desired action. For example, by tracking a “publication recommendation”, it was shown that followers with a high score for the “favored” component had twice as much likelihood of fulfilling a desired action. The learning factor for that example may correspondingly increase a weight attributed to the “favored” component.

### EXAMPLE 2

### Facebook-Based Categorization

An embodiment of a categorization for the Facebook UGC social network is next described.

a. Strength of Relationship

Strength of relationship may be measured in Facebook by looking at interactions between an individual and the individual's “friends”.

In some embodiments, an engagement ratio between an individual and a friend may be calculated based upon identified numbers of “likes”, “comments”, “@messages”, and “shares” where:
“likes” is the number of likes in a friend's timeline of messages on posts from the originators' timeline;
“comments” is a number of comments by a friend on posts from the originators' timeline;
“@messages” is a number of posts in a friend's timeline that contain the originator's Facebook name; and
“share” is a number of shares of posts by a friend of posts from the originators' timeline.

In other embodiments, a calculation of engagement ratio may alternatively or additionally be based on “direct messages”, which is the number of direct messages from the originator's friend to the originator.

Calculation of engagement ratio may further alternatively or additionally be based on mutuality of engagement. Mutuality of engagement may be measured by, for example, “friend_likes”, “friend_comments”, “friend_@messages”, or “friend_shares”, where:
“friend_likes” is a number of likes in the originators' timeline of messages, on posts from a friend's timeline;
“friend_comments” is a number of comments by the originator, on posts from a friend's timeline;
“friend_@messages” is the number of posts in the originator's timeline that contain a friend's Facebook name; and
“friend_shares” is a number of shares of posts by the originator of posts from a friend's timeline.
   b. Affinity with Topics

Affinity with topics may be measured in the Facebook social network by performing an analysis of UGC content in the network. The affinity ratio provides for a ranking of users, similarly to the rankings illustrated above for the Twitter network. The affinity ratio may be calculated for a set of interests defined by keywords. In one embodiment, an affinity ratio between an individual and a friend is calculated based on “profile”, “status”, likes”, “shares”, and “comments”, where:
“profile” measures whether the ‘about me’ section of the friend contains one of the specified keywords;
“status” is the number of times ‘status updates’ by the friend contain one of the specified keywords;
“likes” is the number of times ‘status updates’ liked by the friend contain one of the specified keywords;
“shares” is the number of times shares by the friend contain one of the specified keywords; and
“comments” is the number of times comments by the follower contain one of the specified keywords.

In other embodiments, affinity may alternatively or additionally be calculated based on “direct messages”, which is the number of direct messages from the originator's friend to the originator that contain one of the specified keywords.

### EXAMPLE 3

### Combined Twitter/Facebook-Based Categorization

The examples above related to Twitter and Facebook illustrate concepts of this disclosure for a single UGC network. This next example illustrates leveraging information found in multiple networks. One or more of engagement ratio, affinity ratio, sub-ratios of engagement ratio or affinity ratio, and recommendation score for each of two or more UGC networks may be used to calculate a combined recommendation score. In the combination equations, the following nomenclature is used:
(t) E=Decay engagement ratio from Twitter
(t) A=Decay affinity ratio from Twitter
(t) R=Decay recommendation score from Twitter
(f) E=Decay engagement ratio from Facebook
(f) A=Decay affinity ratio from Facebook
(f) R=Decay recommendation score from Facebook

In one example, a combined recommendation score based on recommendation scores calculated from both Twitter and Facebook is:

Combined recommendation score=(w_{—}t*(t)R)+(w_{—}f*(f)R)

where
w_t is the weight attributed to (t) R, the Decay Recommendation score from Twitter; and
w_f is the weight attributed to (f) R, the Decay Recommendation score from Facebook.

In another example, a combined recommendation score based on engagement ratios and affinity ratios from both Twitter and Facebook is:

Combined recommendation score=[w_{—}te*(t)E)+(w_{—}fe*(f)E)]+[w_{—}ta*(t)A)+(w_{—}fa*(f)A)]

where
w_te is the weight attributed to (t) E, the Decay engagement ratio from Twitter;
w_fe is the weight attributed to (f) E, the Decay engagement ratio from Facebook;
w_ta is the weight attributed to (t) A, the Decay affinity ratio from Twitter; and
w_fa is the weight attributed to (f) A, the Decay affinity ratio from Facebook.

Calculation based on both engagement ratios and affinity ratios allows favoring of information from one of the UGC networks as more important or relevant than the other. For example, one might learn that engagement ratios on Facebook tend to produce higher end results than engagement ratios on Twitter, and hence final recommendations may favor Facebook ratios. As an optimization, the learning model as referenced above can take defined weights into consideration.

Although the combined recommendation scores are shown as being calculated from decay values, in some embodiments, the values without considering delay are used instead.

### Examples of Implementations

### Illustrative Embodiment A: Recommend or Invite to a Publication

An illustrative use of the SNAE of this disclosure is in the field of content marketing. Many brands send out communications (e.g., newsletters) to lists of individuals on a regular basis. These communications are often in a digital form and are the digital counterparts of printed magazines. These newsletters can be useful tools in building brand loyalty and increased purchases by providing relevant information to end-users that are interested in a specific product or service.

A challenge for marketers is to not only create the newsletters and the content, but also to expand the audience of such newsletters. An embodiment focuses on audience expansion.

The embodiment may be a plug-in, which brands and publishers can add to their branded electronic content. The plug-in may collect user identification (ID) information for UGC networks, and offer, for example, added functionality such as sharing of a link with an individual in return for providing the individual's ID. The UGC network as related to that user ID may then be scanned. The scan will reveal the affinity of persons in the individual's network and produce a list of people who are interested in a specific topic, such as a topic identified by keywords by the publishing brand.

In one implementation, the UGC network is Twitter, and a ranking may be built by analyzing the individual's profile to find matches between predefined areas of interest and the individual's communications, along with a frequency analysis (e.g., the number or rate of sent tweets or direct messages).

A frequency analysis may be adjusted by assigning weights to the frequency with which keywords appear, and the ‘freshness’ of the communication.

An individual's network may also be scanned to determine strengths of relationships. To limit network queries and hardware usage, a relationship analysis may be focused on, or selectively applied to, those persons within the individual's network who have shown an affinity for a selected content. Strength of relationship may be defined for Twitter as not only a mutual follower relationship, but by the number of retweets, favorited tweets, direct messages and followers in common. The strength of relationship may be, but is not necessarily, built upon messages about the pre-selected topics of interest.

The affinity and strength of relationship determinations may then be used to generate a list of persons who show an interest in a specific topic, and who show a strong relationship with the originating individual. A ranking may be made for recommendations of persons to the originating individual, asking the individual to “invite” or “share” the electronic content with these persons. The likelihood of the originating individual doing this and the likelihood of a receiving person accepting the share or invite is greatly increased by the existing relationship with the originating individual as well as the affinity with the topic.

Additional persons may be profiled when discovered through the profiling described, or when added manually or in an automated fashion.

### Illustrative Embodiment B: Recommend or Invite to an E-Commerce or On-Line Shopping Application

Another illustrative use is in the field of recommendations as used on e-commerce sites, allowing for more targeted and effective recommendations. A common problem in recommendations and reviews on e-commerce sites presently is that these are almost invariably from people unknown to an individual. A recommendation by a trusted person holds much more weight.

A challenge for marketers in e-commerce is expanding the audience of an e-commerce site. An embodiment focuses on audience expansion.

The embodiment may be a plug-in, which brands and publishers can add to their shopping websites. The plug-in may collect user ID information for UGC networks, and, for example, offer added functionality such as offering coupons in return for providing an ID. The UGC network related to the user ID may then be scanned. The scan would reveal persons in the individual's UGC network who have an affinity with a specific interest which is related to the products or services being sold on the website. A list of people who are interested is then generated, where the interest is identified by keywords from the owners of the shopping site. Examples of keywords include “sports car” or “handbag.” In one embodiment, the UGC network is Facebook, and a ranking may be built by analyzing information such as information in the individual's profile or ‘about’ section to find matches with the predefined areas of interest, likes which shows “interests” and other information, and the individual's communications, along with a frequency analysis (e.g., the number or rate of posts, direct messages and likes).

A frequency analysis may be adjusted by assigning weights to the frequency with which keywords appear, and the ‘freshness’ of the post or communication.

An individual's network may also be scanned for strengths of relationships. To limit network queries and hardware usage, the ‘relationship’ analysis may be focused on, or selectively applied to, those persons within the individual's network who have shown an affinity for selected content. Strength of relationship may be defined for Facebook as not only a mutual friend relationship, but by the number of replies, likes, direct messages and friends in common. The strength of relationship may be but is not necessarily built upon messages about the pre-selected topics of interest.

The affinity and strength of relationship determinations may then be used to generate a list of persons who show an interest in a specific topic, and who show a strong relationship with the originating individual.

A ranking may be made for recommendations of persons, asking an individual to “recommend” or “share” product information with these persons. The likelihood of the originating individual doing this and the likelihood of a receiving person accepting the share or invite is greatly increased by the existing relationship with the originating individual as well as the affinity with the products or services offered for sale on the website.

Additional persons may be profiled when discovered through the profiling described, or when added manually or in an automated fashion.

### CONCLUSION

While the disclosure has been described with reference to the specific embodiments thereof, it should be understood by those skilled in the art that various changes may be made and equivalents may be substituted without departing from the true spirit and scope of the disclosure as defined by the appended claims. In addition, many modifications may be made to adapt a particular situation, material, composition of matter, method, operation or operations, to the objective, spirit and scope of the disclosure. All such modifications are intended to be within the scope of the claims appended hereto. In particular, while certain methods may have been described with reference to particular operations performed in a particular order, it will be understood that these operations may be combined, sub-divided, or re-ordered to form an equivalent method without departing from the teachings of the disclosure. Accordingly, unless specifically indicated herein, the order and grouping of the operations is not a limitation of the disclosure.

What is claimed is:

1. A method, comprising:
receiving information related to user generated content within a plurality of social networks;
categorizing the information; and
using the categorized information:
identifying relationships between a first user and a plurality of second users;
scoring each relationship between the first user and a respective one of the plurality of second users; and
providing a list of recommended users of the plurality of second users.

2. The method of claim 1, wherein categorizing the information includes weighting the information.

3. The method of claim 2, wherein the weighting includes weights based on effectiveness of types of the user generated content in predicting receptiveness to recommendations.

4. The method of claim 2, wherein the weighting includes weights for ones of the plurality of social networks based on effectiveness of user generated content in the ones of the plurality of social networks in predicting receptiveness to recommendations.

5. The method of claim 1, wherein using the categorized information further includes identifying affinities of the plurality of second users for a product or category of products.

6. The method of claim 5, further comprising calculating recommendation scores for the plurality of second users based on scores for the relationships and the affinities, wherein the list of recommended users is based on the recommendation scores of the plurality of second users.

7. The method of claim 1, wherein categorizing the information is performed separately for each of the plurality of social networks, further comprising calculating a recommendation score for each of the plurality of second users for each of the plurality of social networks.

8. The method of claim 7, wherein calculating the recommendation score includes calculating a network recommendation score for each of the plurality of social networks, weighting the network recommendation scores based on effectiveness of user generated content in the respective network in predicting receptiveness to recommendations, and summing the weighted network recommendation scores.

9. A method, comprising:
receiving information related to user generated content within at least one social network;
identifying from the information a relationship between a first user and a second user;
calculating a strength of relationship score for the relationship;
identifying from the information an affinity of the second user for a product or category of product;
calculating an affinity score for the second user based on the affinity of the second user; and
determining a recommendation score for the second user based on the strength of relationship score and the affinity score.

10. The method of claim 9, further comprising determining decay weights for the user generated content based on latency.

11. The method of claim 9, wherein the strength of relationship score is calculated based on information related to user generated content in a first network of the at least one social network, and the affinity score is calculated based on information related to user generated content in a second network of the at least one network.

12. The method of claim 11, further comprising determining decay weights for the first network and the second network based on latency, wherein the recommendation score is determined using the decay weights.

13. The method of claim 11, wherein the strength of relationship score and the affinity score are weighted.

14. A method, comprising:
gathering information related to topical affinities of an individual by electronically scanning a first social network using a first crawler;
gathering information related to one or more relationships of the individual by electronically scanning a second social network using a second crawler;
determining a strength of relationship score for each of the relationships of the individual based on the information gathered from the second social network;
calculating a ranking of each of the relationships of the individual based on the strength of relationship scores and the topical affinities of the individual; and
providing a recommendation list of persons most likely to be influenced by the individual based on the ranking.

15. The method of claim 14, wherein the first social network and the second social network are the same network.

16. The method of claim 14, wherein the first crawler and the second crawler are the same crawler.

17. The method of claim 14, further comprising determining decay weights for the topical affinities and the strength of relationship scores based on latency, and modifying the ranking based on the decay weights.

18. The method of claim 14, further comprising applying decay weights based on latency to the information gathered from the first social networks or the second social network.
